(19) United States
(12) Patent Application Publication
(10) Pub. No.: US 2010/0043364 A1
(43) Pub. Date: Feb. 25, 2010

(54) LIQUID-GAS SEPARATOR, NAMELY FOR VACUUM CLEANER

(75) Inventor: Gerard Curien, Housseras (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: WINDDROP, Fremifontaine (FR)

(21) Appl. No.: 11/813,687

(22) PCT Filed: Apr. 3, 2007
(86) PCT No.: PCT/FR07/51060

§ 371 Date: Jul. 11, 2007

(30) Foreign Application Priority Data
Apr. 4, 2006 (FR) 0602951
Dec. 1, 2006 (FR) 0610563

(51) Int. Cl. A47L 9/18; B01D 45/14; B01D 46/28; B01D 46/14; B01D 35/10; B01D 45/00

(52) U.S. Cl. 55/330; 55/408; 55/401

(57) ABSTRACT

This invention relates to a liquid-gas separator (1), namely for a vacuum cleaner, including, on the one hand, an upstream conduit (3) and a downstream conduit (4) connected through a communication opening (9) and, on the other hand, mounted mobile in rotation inside either conduit, filtering means (5), pervious to gas, and designed capable of conveying by centrifugation the liquid collected at its periphery.

It is characterized in that said filtering means (5) constitutes means for closing said communication opening (9).

### BACKGROUND OF THE INVENTION

(1) Field of the Invention

The invention relates to a liquid-gas separator, namely for vacuum cleaner, including, on the one hand, an upstream conduit and a downstream conduit connected through a communication opening and, on the other hand, mounted mobile in rotation inside either conduit, filtering means, pervious to gas, and designed capable of conveying the collected liquid to its periphery by centrifugation.

The invention also relates to a household electrical appliance including such a liquid-gas separator.

The invention relates to the separation of liquid, namely water, contained in a mixed gas flow, namely air flow, and suspended particles, namely liquid particles. It relates in particular to the field of the household electrical appliances, in particular vacuum cleaners.

Vacuum cleaners with water filtering include a suction device which draws an air flow, loaded with debris and liquid particles, namely water particles, through a vessel containing water. Filtering of the impurities occurs in this water through bubbling, then the air is evacuated towards the outside after passing through a water-air separating system, and after passing through a suction module.

The vacuum cleaners with water filtering have clear advantages compared to traditional vacuum cleaners that include filtering elements, such as filter bags, cyclone systems, or also specific filters, which have the drawback of having to be regularly replaced or cleaned, interposed in the gas-circulation circuit, namely air-circulation circuit:

a vacuum cleaner with water filtering can operate without additional filter;

a vacuum cleaner with water filtering has a constant suction power, unlike the traditional vacuum cleaners in which the filtering media clogs as the use, and in particular the filling of the bag containing the waste, progresses;

a vacuum cleaner with water filtering does not include a bag, the cost of consumables is inexistent, and the maintenance of the appliance is limited;

a vacuum cleaner with water filtering enables the suction of liquids, namely water, which a traditional vacuum cleaner does not;

a vacuum cleaner with water filtering enables the use of additives in the bubbling water, such as disinfectant, deodorant or essential oils, which provides additional functionalities, compared to the traditional vacuum cleaners, and in particular the possibility of eliminating acarids;

a vacuum cleaner with water filtering also allows humidifying the air, which can sometimes be sought for.

(2) Description of the Prior Art

The main technical difficulty met when developing vacuum cleaners with water is due to the fact that during the bubbling in the tank the air flow carries water droplets. These droplets must imperatively be separated from the air, and be eliminated before the air flow passes through the suction module and before the rejection into the atmosphere of the room.

WO 0154798 describes a vacuum cleaner with water filtering that uses devices for separating water and air derived from the traditional filters, such as porous filters in the form of water-resistant membranes made out of plastic or polymer foams.

Such separating devices are not satisfactory, because, as for the traditional paper filters, a clogging of the pores by water or unfiltered fine dust always occurs in the more or less long term. Because of this clogging, the user observes a loss of power of the vacuum cleaner and must stop the work, in order to clean or replace the filter. The prior art tried to solve these problems, of water passing beyond the filter as well as of clogging of the filter, through increasing the internal volume of the appliance, which is prejudicial to its handiness, or through an important reduction of the air flow, which is prejudicial to its suction efficiency. An identical problem can be observed with the shampooing machines provided with comparable devices. The maintenance of the filters, in particular filters made out of foam, which must regularly be removed, cleaned, or replaced, gives rise to particular problems of hygiene, cleaning difficulty, and cost.

US2001/0015132 describes a system including a conical separator with rotary vertical blades, which neither gives complete satisfaction when it is used alone, because it is also characterized either by a restricted air flow or by a larger tank volume or also by a less dynamic water-air mixing, thus reducing the filtering quality.

Such vacuum cleaners with water filtering, though they have many advantages, are therefore not completely satisfactory.

GB 2 360 471 describes a self-cleaning filter for a vacuum cleaner, which includes a helical brush rotating inside a cylindrical sieve filter which it is in permanent contact with, so as to generate an electrostatic load and to convey the dust towards a collecting zone. Such a system is obviously designed only for air containing dry dust, and cannot be suitable for a vacuum cleaner with water.

GB 2 382 042 describes a water-air separator, which includes a chamber in which a rotary brush rotates, through which one urges the air flow loaded with impurities to pass in the direction of the axis of rotation of the brush. The latter impedes the air flow from passing and fixes by capillarity the elements suspended in the air, in particular water, which is guided along the bristles of the brush under the action of the centrifugal force, and is ejected towards the peripheral wall of the chamber, which is at a distance from the brush, then towards collecting and evacuating zones. This solution has however drawbacks related to the important pressure loss of the air flow in baffles and the changes of direction, which the suction device must overcome, and therefore results into an increase of the level of noise. The efficiency is imperfect, because of an outlet of the air flow that is either radial or axially annular and very far from the axis of rotation. The connection in series of several brushes, even of traditional filtering means made out of porous materials, shows that the arrangement with one brush is not sufficient, in this case, to completely solve the problem set forth, which is to completely separate water from the air flow during the passage through the separator. In addition, such a combination of several separating means mounted in series inevitably leads to an important increase in volume and weight, which makes more difficult an application in the field of the household electrical appliances where performance, compactness and lightness are sought, in particular for portable equipment.

### SUMMARY OF THE INVENTION

The invention is aimed at coping with these main difficulties by providing a liquid-gas separator, in particular a water-air separator, with an improved output, adaptable in particular onto a vacuum cleaner with water filtering and onto portable appliances.

This invention relates to a liquid-gas separator, namely for a vacuum cleaner, including, on the one hand, an upstream conduit and a downstream conduit connected through a communication opening and, on the other hand, mounted mobile in rotation inside either conduit filtering means, pervious to gas, and designed capable of conveying the collected liquid to its periphery by centrifugation, characterized in that said filtering means constitutes means for closing said communication opening.

According to a feature of the invention, said communication opening has a cross-section that is smaller than the passage cross-section of said upstream conduit, so as to define at least one resting rim, in cooperation with which said filtering means constitutes closing means.

According to another feature of the invention, said filtering means is radially separated from the walls of said upstream conduit.

According to a feature of the invention, said resting rim is that of a mobile turbine rotating in said opening about said axis of rotation.

According to another feature of the invention, said resting rim includes a seal, or is designed capable of cooperating with a seal mounted integral with said filtering means.

The invention also relates to a household electrical appliance, including means for generating an air flow, and including, between an upstream conduit and a downstream conduit, at least one such liquid-gas separator.

Further features and advantages of the invention will become clear from the following detailed description of non-restrictive embodiments of the invention, with reference to the attached figures.

### BRIEF DESCRIPTION OF THE DRAWINGS

FIG. 1 is a schematic partial and cross-sectional view of a liquid-gas separator, in particular a water-air separator, according to a first embodiment of the invention;

FIG. 2 is a schematic partial and cross-sectional view of a variant of the first embodiment of the invention;

FIG. 3 is a schematic partial and cross-sectional representation of a liquid-gas separator according to a second embodiment of the invention;

FIG. 4 is a schematic partial and cross-sectional representation of a variant of the second embodiment of the invention;

FIG. 5 is a schematic partial and cross-sectional representation of another variant of the second embodiment of the invention;

FIG. 6 is a schematic partial and cross-sectional representation of a variant of FIG. 5;

FIG. 7 is a schematic partial and cross-sectional representation of a detail of sealing means of a separator according to the invention;

FIG. 8 is a schematic partial and cross-sectional representation of another detail of sealing means of a separator according to the invention;

FIG. 9 is a schematic partial and cross-sectional representation of another detail of sealing means of a separator according to the invention;

FIG. 10 is a schematic partial and cross-sectional representation of another detail of sealing means of a separator according to the invention;

FIG. 11 is a schematic partial and perspective representation of a variant of a brush of a separator according to the invention;

FIG. 12 is a schematic partial representation of a detail of an implementation variant of the invention.

### DETAILED DESCRIPTION OF THE PREFERRED EMBODIMENTS

The invention relates to the separation of fluids contained in gases, in particular in the field of the household electrical appliances, namely of the vacuum cleaners with liquids, water filtering, and the like.

A liquid-gas separator 1 includes an upstream conduit 3, which conveys a gas flow loaded with impurities and/or liquid, and a downstream conduit 4, intended for evacuating the gas deprived of any liquid and any impurity. These upstream 3 and downstream 4 conduits are connected through a communication opening 9.

The invention, in all its embodiments and its variants, is applicable to any gas and any liquid. In the further description, reference is made in particular to a particular application where the gas is air, and the liquid is water: then, a water-air separator is involved.

A gas flow F is generated from the upstream conduit 3 to the downstream conduit 4 under the action of suction or pressurization means. In particular in the case of a vacuum cleaner with water filtering, the separator 1 is classically positioned between a tank containing water for bubbling the gas flow, namely air flow, entering upstream, and a gas-suction conduit, namely an air-suction conduit, connected to the suction motor.

The separator 1 includes means 2 for conveying the gas flow F between the upstream conduit 3 and the downstream conduit 4, through which thus flows this gas flow.

In the case of a vacuum cleaner with water filtering, the gas flow, in particular air flow, is deprived, during the bubbling upstream of the separator 1, of the majority of its contaminants, but it is loaded with liquid droplets, in particular water droplets. This gas flow, in particular air flow, is brought, under the action of the depression, towards the separator 1, the main function of which is to eliminate said droplets and to recover the eventually humidified dust that would be drawn into the mist formed during the bubbling.

The separation between the liquid, in particular water, and the gas flow, in particular air flow, occurs when the gas flow meets at least one filtering means 5, mounted mobile in rotation inside either upstream 3 or downstream 4 conduit, preferentially the upstream conduit 3, and interposed on the passage of the flow F, inside the chamber or of the channel formed by the conveying means 2. This filtering means 5 is designed capable of being submitted to a rotational movement about an axis of rotation 6. In a preferred embodiment, the filtering means 5 is formed by a brush.

The filtering means 5 is pervious to gas, and is designed capable of conveying the collected liquid to its periphery, by centrifugation. The collecting of the liquid occurs by a stopping effect achieved through the rotation of the filtering means 5, about its axis of rotation 6, in combination with the capillarity along this filtering means 5, which allows to radially guide the liquid drops towards the periphery of this filtering means 5.

This filtering means 5 is an obstacle for the particles present in the gas flow, in particular air flow, in particular to the liquid drops, in particular water drops. These particles have a tendency to be fixed by capillarity to the elements the filtering means 5 are comprised of, which, in particular if this filtering means 5 is a brush, can be bristles, fins or the like. Such a brush 5 is preferably provided with bristles designed capable of radially separating from the axis of rotation 6, during its rotation, liquid drops, in particular water, or/and impurities the gas flow F includes, in particular air, resulting from the upstream conduit 3.

The glued or/and welded bristles, or sets of bristles, forming the brush or brushes can be more or less dense, of any natural, synthetic, animal material, of various shapes and profiles, in particular small blades, fixed by any known flexible or rigid means, and distributed according to various configurations on a disc or a tube, without departing from the scope of the invention. In order to enhance the separating power, the sets of bristles can be provided at several levels, so as to form, if necessary, a complex lattice through which gas, in particular air, can pass, but through which the liquid, in particular water, cannot pass.

Under the action of the rotation of the filtering means 5, in particular a brush, and the centrifugal force, the particles, in particular liquid or water particles, are radially separated from the axis of rotation 6 of the filtering means 5. The filtering means 5 can namely be comprised of a succession of brushes, if necessary, in particular coaxial and alternately mounted brushes. The sets of bristles are homogeneously distributed over the periphery of the disc serving as a support, in order to form a brush 5. In order to form the filtering means 5, bristles are advantageously grouped into more or less compact sets fixed to the disc by any known means. The sets of bristles can consist of some bristles, up to several tens, depending on the nature of the bristles, their size and the type of brush to be formed. Preferably, according to the types of manufacture used, the bristles or the sets of bristles are arranged substantially in the plane of the disc, so as to form a flat brush 5, however, it can be contemplated to orient the sets of bristles towards the gas flow, in particular air flow F, entering upstream, and to thus form filtering means, in particular a globally concave brush. It is also conceivable to orient the sets of bristles in the opposite direction and to form a globally convex shape with respect to the flow F. This principle of inclination of the sets of bristles is also adaptable to a tubular brush. Of course, intervals can exist between beams of bristles. A high speed of rotation of the filtering means 5, namely a brush, allows preventing the direct passing of the liquid flow through the filtering means, namely a brush, through these intervals.

In the case of a brush 5 with fins, the latter are advantageously alternately mounted radial elements having the shape of substantially flat blades laterally edged by at least one rim of a thickness preferably smaller than their thickness, as can be seen in FIG. 11. This rim is preferably protruding on the side of the arrival of the flow F on the filtering means, namely a brush.

In an implementation variant, as can be seen in FIG. 4, the filtering means 5 is a tubular brush 24 the bristles 34 of which are radially mounted on a tubular body including perforations 25, and a first end 26 of which, on the side of the upstream conduit 3, is closed, and the other end 27 of which, on the side of the downstream conduit 4, is hollow, so as to allow the flow of gas, namely air, into the communication opening 9. Here too, the sets of bristles of the brush 24 must be sufficiently separated from the wall 7 of the conveying means 2, in order to allow the proper flow of the elements separated under the effect of the rotation of the brush 24, along the wall 7.

The filtering means 5, namely a brush, can be driven in rotation about the axis of rotation 6 by motorization means 13 driving a shaft 3 1, or also by an organ such as a turbine driven by the flow F passing through the separator 1. In a particular version, the separator 1 includes means for adjusting the speed of rotation of the filtering means 5 depending on the pressure difference between the upstream 3 and downstream 4 conduits, or/and the flow rate of the gas flow in the separator 1.

The filtering means 5 is maintained radially separated from the walls of the upstream conduit 3, namely the conveying means 2, in order to allow the projection of the liquid or water droplets on the wall 7 of the latter under the action of the rotation of the filtering means 5, their collection at the level of a substantially annular peripheral zone 22, about the periphery of the filtering means 5, which zone is vast enough to prevent the formation of a swirl, and to allow the free flowing of the liquid or water drops along this wall 7, without any local accumulation that would be prejudicial to the proper operation of the separator 1.

One understands that any pressure loss on the gas flow, namely air flow, is prejudicial to the output of the appliance on which it is installed. This is why, though one can perfectly contemplate mounting several filtering means 5 in series on the flow F, it is preferable to provide a configuration with the minimal number of filtering means 5, allowing the complete separation of the liquid contained in the entering gas flow, and also an economical operation. To this end, the object of the invention is to combine the effectiveness of separation of the liquid with a minimum alteration of the gas flow in terms of pressure losses, and the separator 1 includes means allowing bringing about tightness between the filtering means 5 in rotation and the conduit in which flows the liquid-gas flow. Maintaining the flow rate of the gas can also be achieved, when using a brush to form the filtering means 5, by reducing the number of beams of bristles forming it, in combination with increasing the speed of the latter.

The conveying means 2 are closed by a partition 8, which includes the communication opening 9 between the upstream 3 and downstream 4 conduits. This opening 9 is preferably a single opening, in order to avoid any parasitic-gas flow.

In a preferred application, the communication opening 9 has a cross-section that is smaller than the passage cross-section of the upstream conduit 3, so as to define at least one resting rim 10, in cooperation with which the filtering means 5 constitutes closing means.

The resting rim 10 is preferably perpendicular to the axis of rotation 6 of the filtering means 5. Preferably, the latter 5 includes a downstream face 5A that is, in a preferred implementation variant, substantially flat at the level of its surface entering into contact with the resting rim 10 and perpendicular to the axis of rotation 6. This arrangement allows ensuring that the whole gas flow dried during the passing through the filtering means 5 continues its flow towards the downstream side, through the opening 9.

It should be noted that, if for an easy implementation, the axis of rotation 6 of the filtering means 5 is parallel to flow F in the area of the filtering means 5, their relative orientation can be different, without departing from the invention.

Preferably, in order to achieve a reduced size and a reduced cost the filtering means 5 has the shape of a flat disc, perpendicular to its axis of rotation 6. Preferably, the filtering means 5 extends radially, with respect to the axis of rotation 6, beyond its points of contact 11 with the resting rim 10, which allow avoiding any edge or turbulence effect, and especially any re-infiltration of liquid, namely water, downstream of the filtering means 5. It is indeed necessary to avoid the penetration towards the downstream side of the liquid that is present in the vicinity of the opening 9 in the partition 8. Filtering means 5, namely a brush, the diameter of which would be equivalent to that of this opening 9 would be more pervious to the passing through of a liquid flow by capillarity.

Preferably, as can be seen in the figures, the communication opening 9 is designed capable of pushing back the flow F downstream of the filtering means 5 in the vicinity of the axis of rotation 6. In an implementation variant, as can be seen in FIG. 3, the communication opening 9 adopts the shape of a suction cone 23 converging towards the downstream conduit 4, it should be noted that it is useful, at the level of the filtering means 5, to have a widening of the passage, in order to allow a better passing of the flow F through the filtering means 5.

In a first preferred embodiment, the separator 1 includes a resting rim 10 that is mobile in rotation about the axis of rotation 6. In particular, this resting rim 10 can be synchronized in rotation with the filtering means 5, for example through their being mounted on the same driving shaft. The synchronization is particularly useful when the separator 1 is integrated into a vacuum cleaner with water filtering, in order to prevent any heating if the user inadvertently forgets to perform the filling with water.

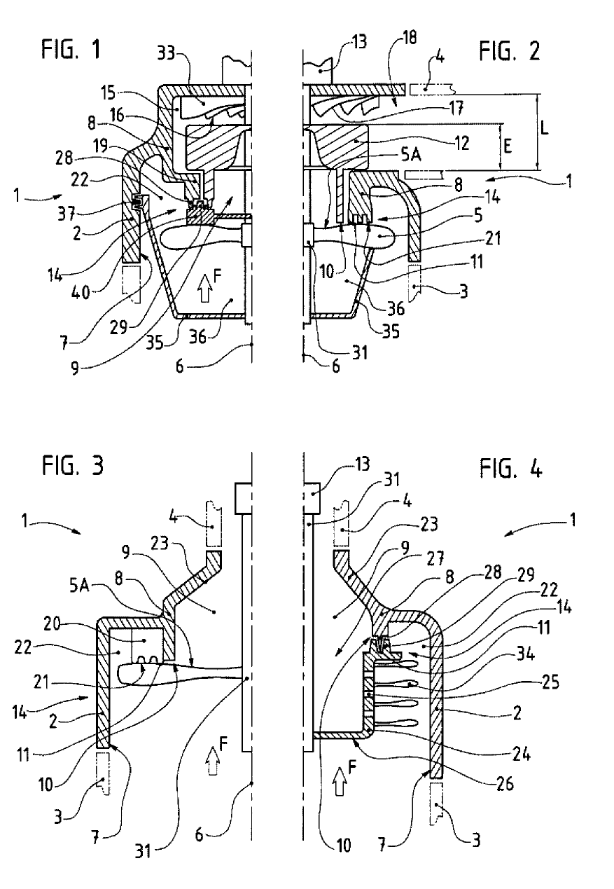

In a preferred embodiment, as can be seen in FIG. 1, the resting rim 10 is the end of a turbine 12, which is mobile in rotation in the opening 9 about the axis of rotation 6. This turbine 12 can be equipped with its own motorization means 13, or to be directly driven by the flow F in the separator 1, or also be mounted on a shaft driven by another turbine 32 driven by this gas flow, namely air flow. Advantageously, in an embodiment as can be seen in FIG. 2, the turbine 12 drives the filtering means 5, which it is assembled with. In an implementation variant as can be seen in FIG. 12, the end of a turbine 12, fixed to the filtering means 5, and forming a resting rim 10, in this case advantageously notched or corrugated, so as to be adapted to the constitution of the filtering means 5, when the latter consists of a brush classically formed of radially and alternately mounted tufts of bristles. The presence of the turbine 12 can also allow compensating for the pressure losses due to the passage of the gas flow F, namely air flow, through the filtering means 5.

In brief, several drive configurations are possible: driving means formed, as the case may be, by motorization means 13 or the gas flow F itself, can drive, together or separately, only the filtering means 5, or a turbine 12, or also the filtering means 5 and a turbine 12, or also another turbine 32 that drives, in turn, the filtering means 5, or a turbine 12, or the filtering means and a turbine 12.

Advantageously, the body of the separator 1 is molded, and the upstream conduit 3, the downstream conduit 4, the conveying means 2 and partition 8 form a solid organ, which defines the opening 9. The turbine 12 is mobile in rotation in a chamber 15 downstream of the filtering means 5, which chamber 15 is preferably a part of the same molded solid organ. Advantageously, as can be seen in FIG. 2, a face 16 of the chamber 15, substantially perpendicular to the axis of turbine 12, is separated from a face 12A of said turbine 12 that is most downstream in the flow F. To this end, the thickness E of the turbine 12 is smaller than the width L of this chamber 15. The latter preferably includes channels 17 for deviating the gas towards a peripheral end 18 of the chamber 15, connected to said downstream conduit 4. The face 16 that incorporates the channels 17 can directly form a wall of the chamber 15, or belong to an intermediate part placed in front of the latter.

In a second embodiment, as can be seen in FIGS. 3 to 6, the resting rim 10 includes a seal 20, or is designed capable of cooperating with a seal 20 mounted integral with said filtering means 5.

In a preferred embodiment, this seal 20 includes closed grooves 21, which are designed capable of enclosing, during the rotation of the filtering means 5, substantially 0-shaped volumes of liquid, namely water, which constitute a liquid seal that reduces the frictions and ensures lubrication. Thus, the surface of contact is limited. It should also be noted that the seal 20 can advantageously be star-shaped, so that the contact between the filtering means 5 and the seal 20 does not always occur at the same point, in order to avoid a localized heating of the seal 20. When the filtering means 5 consists of a brush, this seal 20 is into contact with the upper row of the sets of bristles of the brush 5 when several rows of bristles or several superposed flat brushes are present. In this same case, the surface of the seal 20 is advantageously in the same plane as that formed by the upper face of the sets of bristles of the brush 5, this so as to form a friction surface and a liquid seal, namely a water seal, irrespective of the orientation of the sets of bristles. The presence of the peripheral zone 22 in which the liquid, namely water, and the debris accumulate before flowing along the wall 7 of the conveying means 2 is favorable for forming the liquid joint, namely water seal, in the zone of contact between the seal 20 and the sets of bristles of the brush.

In an implementation variant as can be seen in FIGS. 1, 5 and 7, the seal 20 consists of a massive or annular disc 40 mounted coaxially to the filtering means 5, mobile in rotation or driven by the latter. The tightness of such a disc 40 is required only at the level of the resting rim 10. In the case of an annular disc 40, it preferably includes, to avoid the eventual discontinuity of the filtering means 5, spikes for fixing it to a shaft 31 passing through the axis of rotation 6, said axis 31 preferably being the one driving the filtering means 5, as well as the turbine 12 in the first embodiment. Such an annular disc 40 can advantageously be provided, on its complete surface included between the filtering means 5 and the opening 9, with a membrane, namely consisting of a very fine sieve, the calibration of which is designed to stop dry dust: this design allows, in the event the separator 1 is incorporated in a vacuum cleaner with water filtering, avoiding the drawbacks associated with the lack of water supply by the operator. In an implementation variant including a disc 40 assembled with the filtering means 5 formed by a brush, the end of this disc in contact with the brush is advantageously notched or corrugated, in order to be adapted to the constitution of the brush, when the latter is classically formed by radially and alternately mounted tufts of bristles.

In a preferred implementation of the various embodiments, the separator 1 includes tightening means 14, implanted at the level of the opening 9, in order to prevent the penetration of liquid, namely water, into the latter. Various cases can be contemplated. In the implementation of the separator 1 in its first embodiment with a turbine 12, the tightening means 14 can include a ring 19 connected to the opening 9 and the resting rim 10, whether applied or not against the partition 8, or formed by such a ring 19. The ring 19 extends the partition 8 at the level of the resting rim 10 the turbine 12 then includes, as can be seen in FIGS. 2 and 10. In all the embodiments, the tightening means 14 can also include an intermediate disc 40 inserted between the resting rim 10 and the filtering means 5, as can be seen in FIGS. 1 and 7. The tightening means 14 can be multiple, as can be seen in FIGS. 8 and 9. The particular case of FIG. 8 corresponds to a particularly advantageous configuration, since it includes few parts and is thus of a low cost, and it allows, for the same outer size, having a large-diameter turbine 12, allowing a widening of the opening 9 and improving the efficiency of the filtering means 5.

Preferably, the resting rim 10 includes first tightening means 28, which are designed capable of cooperating with first complementary tightening means 29 the filtering means 5 includes, or an intermediate disc 40 mounted so as to rest against the latter. The first tightening means 28 are preferably formed by one or several grooves which are designed capable of cooperating with one or several tongues that form said first complementary tightening means 29, or vice-versa. As can be seen in FIGS. 1, 7 and 10, in the case of a ring 19 mounted adjacent to the turbine 12, each of them can include such grooves or tongues.

In a particular implementation variant, the resting rim 10 is annular. This configuration allows, if the face 10 is centered on the axis of rotation 6, the best penetration of the gas flow, namely air flow, into the opening 9, and thus the minimal pressure loss.

The molded design of the conveying means 2 forming the body of the separator 1 has an economical advantage because of the simplified mounting, and a reduction in weight and volume. The inner volume as well as the internal elements, such as for example the turbines or the faces and walls of the various channels and chambers can be covered with a sound-proof coating or surface treatment.

The liquid-gas separation mechanism described in the invention according to the various variants is based on the constraint put on the gas flow, namely air flow, to pass through the flat or cylindrical filtering means, provided with sets of bristles in the case of a brush, rotating at high speed.

The speed of rotation of the filtering means 5 is typically higher than 3000 revolutions per minute and preferably higher than 4000 revolutions per minute.

The liquid-gas separation efficiency in the separator 1 essentially depends on the width of the resting rim 10, the speed of rotation of the filtering means 5 with respect to the speed of the gas flow F, and the internal configuration of the filtering means 5.

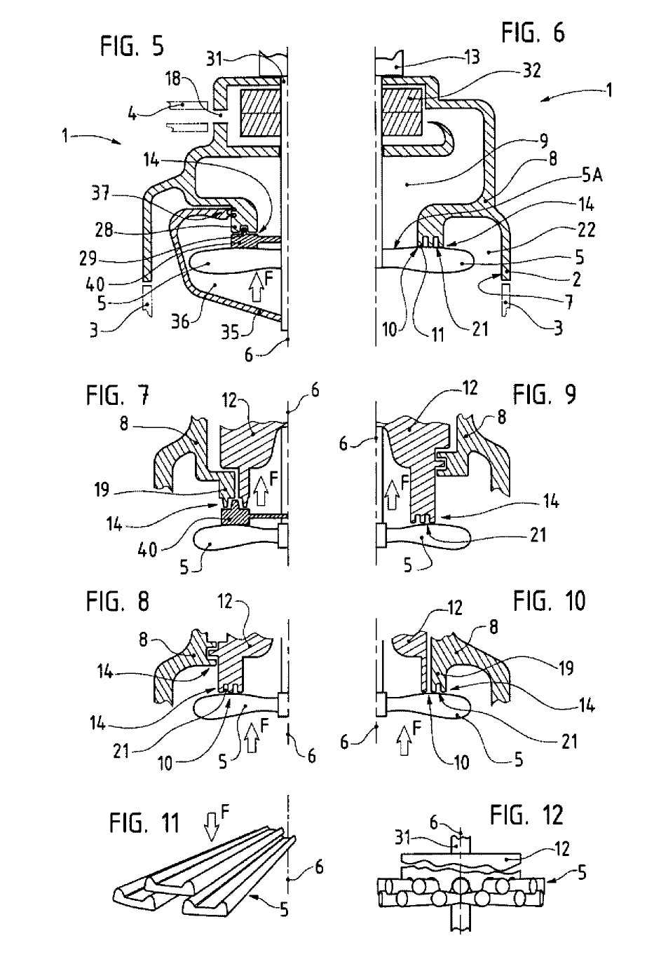

According to an implementation variant, there can be contemplated a additional device 35 for separating the liquid-gas flow F, upstream of the filtering means S in the separator 1, so as to perform a first separation, in particular of dust. Indeed, in the event of using a liquid-gas separator according to the invention in a vacuum cleaner with water filtering, the separation of dust upstream of the filtering means 5 allows being secured in the event the user omits to fill the bubbling chamber with water. Advantageously, such an additional separating device 35 includes a sieve or filter mobile in rotation about the axis 6, and is mounted upstream of the filtering means 5. Preferably, it is designed capable of being driven in rotation about the axis of rotation 6. In a preferred implementation, as can be seen in FIGS. 1, 2 and 5, it forms a chamber 36 in cooperation, as the case may be, with the filtering means 5 as can be seen in FIG. 2, or with the conveying means 2 as can be seen in FIG. 1, or as can be seen in FIG. 5 with the partition 8 or the ring 19. This chamber 36 thus formed, upstream of the filtering means 5 in the first case, or about the latter in the other cases, is thus dust-tight, but not liquid-tight. Advantageously, in its cooperation with the conveying means 2, or the partition 8, or the ring 19, the additional device 36 includes tightening means 37, such as a groove and tongue or the like. This device 35 has preferably a truncated general shape. This shape facilitates, when the axis 6 is vertical and the upstream conduit 3 is in the lower position, the auto-cleaning of the sieve thanks to the liquid running off: thus and under the action of the rotation at high speed, the sieve forming the device 35 is only slightly, or not at all, clogged, and causes only a very low pressure loss in the flow F. The device 35 can also be implanted upstream of the separator 1. Here too, it can be motorized, for example through an extension of the axis 31 bearing the filtering means 5, including a quick coupling, for example a bayonet coupling, to this device 35 for its driving in rotation. The device 35 can then very easily be removed for an eventual cleaning or replacement.

In an implementation variant, this additional separating device is a tubular brush 24 the bristles of which are radially mounted on a tube including perforations 25, a first end 26 of which on the side of the upstream conduit 3 is closed, and the other end 27 of which on the side of the downstream conduit 4 is hollow so as to allow the flow F to flow towards the filtering means 5.

In another implementation variant, a separation of dust can efficiently be ensured by the interposition of a membrane filter on a disc 40 adjacent to the filtering means 5.

In an implementation variant, as can be seen in FIGS. 5 and 6, the shaft 31 of the filtering means 5, or 24 as the case may be, is that of a turbine 32 installed downstream of the opening 9, at the outlet of the separator 1 and driven by the flow F.

The separator 1 is advantageously designed capable of being tightly connected to a bubbling tank for the upstream gas flow F by connecting means designed capable of conveying towards this tank the liquid, namely water, collected against the walls 7 of the conveying means 2 upstream of the filtering means 5 under the effect of the rotation of the latter.

The liquid-gas separator according to the invention has many advantages. It does not clog, unlike the separators formed with water-impervious porous filters. Its pressure loss is constant over time, which means that the suction power of a household electrical appliance incorporating such a separator 1 remains constant in the course of time. Indeed, it allows maintaining a gas flow-rate, namely an air flow-rate constant, since the separator according to the invention is self-cleaning and can neither get clogged nor filled with dirt. Therefore, the user has no unpleasant maintenance to perform. The liquid-gas separation efficiency is very good, which reduces the rejections of dust into the environment, and also prevents an excessive humidification of the surrounding atmosphere. This separator allows designing a simplified gas circuit and its morphology allows improving the compactness and the reduction of the cost of the appliance in which it is mounted.

In the particular case of its use in a household appliance such as a vacuum cleaner, the separator 1 according to the invention has the advantage that it allows making a removable filter body adaptable between the body and the pipes of a traditional vacuum cleaner for dust, while allowing omitting the paper bag, the suction of liquids or maintaining a constant air flow-rate. The use of the principle of water-filtering coupled to the use of a separator 1 according to the invention can advantageously be adapted to various types of household appliances such as shampooing machines, ejector-extractor, suction brush, vapor-cleaner, and the like.

The invention relates to any household electrical appliance including means for generating an air flow F, and including, between an upstream conduit 3 and a downstream conduit 4, at least such a separator 1.

1. Liquid-gas separator, namely for vacuum cleaner, including, on the one hand, an upstream conduit and a downstream conduit connected through a communication opening and, on the other hand, mounted mobile in rotation inside either conduit, filtering means, pervious to gas, and designed capable of conveying the collected liquid to its periphery by centrifugation, wherein said filtering means constitutes means for closing said communication opening.

2. Liquid-gas separator according to claim 1, wherein said communication opening has a cross-section that is smaller than the passage cross-section of said upstream conduit, so as to define at least one resting rim, in cooperation with which said filtering means constitutes closing means.

3. Liquid-gas separator according to claim 1, wherein said filtering means is maintained radially separated from the walls of said upstream conduit.

4. Liquid-gas separator according to claim 1, wherein said filtering means is disc-shaped.

5. Liquid-gas separator according to claim 1, wherein said resting rim is perpendicular to the axis of rotation of said filtering means.

6. Liquid-gas separator according to claim 5, wherein said resting rim is mobile in rotation about said axis of rotation and designed capable of being synchronized with the rotation of said filtering means

7. Liquid-gas separator according to claim 1, wherein said filtering means extends radially, with respect to said axis of rotation, beyond its points of contact with said resting rim.

8. Liquid-gas separator according to claim 1, wherein said resting rim is the end of a turbine mobile in rotation in said opening about said axis of rotation.

9. Liquid-gas separator according to claim 8, wherein said turbine is driven by a gas flow passing through said separator, or by motorization means.

10. Liquid-gas separator according to claim 8, wherein it includes tightening means at the level of the recess of said turbine in said opening for preventing the penetration of liquid into said opening.

11. Liquid-gas separator, in particular water-air separator, according to claim 10, wherein said tightening means include a ring connected to said opening and to said resting rim.

12. Liquid-gas separator according to claim 8, wherein said turbine is integrated into a chamber a face of which, substantially perpendicular to the axis of said turbine, is separated from a face of said turbine most downstream in a gas flow passing through said separator, and is provided, in front of the latter, with channels for deviating the gas towards a peripheral end of said chamber connected to said downstream conduit.

13. Liquid-gas separator according to claim 1, wherein the aforementioned resting rim includes a seal, or is designed capable of cooperating with a seal mounted integral with said filtering means.

14. Liquid-gas separator according to claim 13, wherein said seal includes closed grooves, designed capable of enclosing, during the rotation of said filtering means, substantially O-shaped volumes of liquid ensuring lubrication.

15. Liquid-gas separator according to claim 13, wherein said seal is formed by a massive or annular disc mounted coaxial to said filtering means, freely rotating or driven by the latter.

16. Liquid-gas separator according to claim 1, wherein said resting rim includes first tightening means, designed capable of cooperating with first complementary tightening means the filtering means includes, said first tightening means being formed by one or several grooves designed capable of cooperating with one or several tongues forming said first complementary tightening means or vice-versa.

17. Separator liquid-gas according to claim 1, wherein it includes an additional device for separating dust placed in a gas flow passing through said separator upstream of said filtering means, and designed capable of being driven in rotation about said axis of rotation and of forming a chamber in co-operation, as the case may be, with said filtering means, or with said conveying means or said partition to which said additional device is designed capable of being connected through tightening means.

18. Liquid-gas separator according to claim 1, wherein said filtering means is driven in rotation by motorization means.

19. Liquid-gas separator according to claim 1, wherein said filtering means is comprised of alternately arranged radial elements in the form of substantially flat blades laterally edged by at least one rim.

20. Liquid-gas separator according to claim 1, wherein said filtering means consists of a brush.

21. Liquid-gas separator according to claim 20, wherein said brush is a tubular brush the bristles of which are radially mounted on a tube including perforations, a first end of which on the side of said upstream conduit is closed, and the other end of which on the side of said downstream conduit is hollow, so as to allow the flow of gas into said communication opening.

22. Liquid-gas separator according to claim 17, wherein said additional separating device is a tubular brush the bristles of which radially mounted on a tube including perforations, a first end of which on the side of said upstream conduit is closed, and the other end of which on the side of said downstream conduit is hollow so as to allow the gas to flow towards said brush.

23. Household appliance, including means for generating an air flow, and including, between an upstream conduit and a downstream conduit, at least one liquid-gas separator according to claim 1.
